(19) United States
(12) Patent Application Publication
(10) Pub. No.: US 2020/0151660 A1
(43) Pub. Date: May 14, 2020

(54) NETWORK COMPUTING SYSTEM FOR DETECTING AUDITORY INDICATORS OF ACTIVITY

(71) Applicant: Uber Technologies, Inc., San Francisco, CA (US)

(72) Inventor: Andrew Martin Warr, San Francisco, CA (US)

(21) Appl. No.: 16/190,617

(22) Filed: Nov. 14, 2018

(51) Int. Cl. G06Q 10/08; G10L 25/78; G10L 15/22

(52) U.S. Cl. CPC G06Q 10/0834; G10L 2015/223; G10L 15/22; G10L 25/78

(57) ABSTRACT

A network computing system receives a request from a user device. Based on the request, the network computing system transmits order information to a supplier device to fulfill the request. A recording device at the location of the supplier can capture audio data for the location, and the audio data can be processed to determine sound metrics that are relevant to a level of activity at the location. The network computing system can estimate the level of activity at the location by using the sound metrics. Based on the estimated level of activity at the location, the network computing system can predict an order preparation time for the request and a completion time for the request.

### TECHNICAL FIELD

Examples described herein relate to a network computing system to detect auditory indicators of activity.

### BACKGROUND

Numerous on-demand services exist to offer users a variety of services: transportation, shipping, food delivery, groceries, pet sitting, mobilized task force and others. Typically, on-demand services leverage resources available through mobile devices, such as wireless (e.g., cellular telephony) devices, which offer developers a platform that can access sensors and other resources available through the mobile device. Many on-demand services include dedicated applications to communicate with a network service through which the on-demand service is offered.

### BRIEF DESCRIPTION OF THE DRAWINGS

FIG. 1 illustrates an example system for busy restaurant detection, in accordance with some aspects.

FIG. 2 illustrates a network computing system to coordinate completion of order requests with arrival times of transportation providers, according to one or more examples.

FIG. 3 illustrates an example method for selecting a service provider to transport a delivery order, according to one or more examples.

FIG. 4 illustrates an example method for predicting an order preparation time, according to one or more examples.

FIG. 5 is a block diagram illustrating an example computing device executing and operating a designated service application for communicating with a network computing system, according to examples described herein.

FIG. 6 is a block diagram that illustrates a computer system upon which aspects described herein may be implemented.

### DETAILED DESCRIPTION

Examples provide for a network computing system that detects auditory indicators of activity and coordinates the arrival time of transportation providers in picking up delivery orders from suppliers (e.g., restaurants) with the expected completion times of goods (e.g., food items, boxed items) in the delivery order. For example, the network computing system can target the arrival time of a selected transportation provider to be within a threshold duration (e.g., two minutes) of the completion time of the request for the delivery order. In order to more accurately estimate the completion time of the request at the restaurant, a microphone at the restaurant monitors ambient noise, which is used to estimate a level of activity at the restaurant and its expected effect on the completion time of orders placed with the restaurant.

In some aspects, a restaurant receives an order on a terminal device, such as a tablet computer, running an application that communicates with the network computing system that manages the on-demand delivery service. An employee or automated system accepts the order for the restaurant, prepares the ordered items, then marks the order as ready to pick up. In order to select delivery providers, the network computing system can use computer models that predict order preparation time using contextual features (day of week, time of day, number of items, cost) and/or restaurant data (hardcoded prep time, location).

In order to add a contextual, dynamic (e.g., real-time) element to the order preparation time model, the microphone built-in to the restaurant's terminal device can be sampled to determine how busy the restaurant is based on the sound detected. The terminal device is typically placed near registers or the hostess booth at the front of the restaurant, which allows the microphone to capture sound in a large area of the restaurant. In one implementation, detected sound is an additional feature or input to the existing prediction model. In an alternate implementation, detected sound is a stand-alone method for determining order prep time.

Among other benefits, implementations described herein for detecting a level of activity at a supplier (referred to herein as busy restaurant detection) increases the efficiency and reliability of an on-demand delivery service, reduces wait times for transportation providers, and provides ordering consumers (e.g., users requesting food) with more accurate delivery time estimates. Furthermore, busy restaurant detection can free suppliers from having to manually gauge their level of activity and guess their current order preparation times, thus streamlining the order and preparation process of the on-demand delivery service.

In addition to other implementations, the supplier can choose to disable the microphone recording sounds at certain times or disable it altogether. Implementations described herein process and analyze captured sounds on the terminal at the place of business and upload a set of sound metrics to the network computing system. The terminal does not retain captured sound or associate sound with individuals, thereby protecting the privacy of any customers and employees of the restaurant.

In one aspect, a network computing system receives, over one or more networks, data corresponding to a request from a user device. Based on at least a portion of the data corresponding to the request, the network computing system transmits order information to a supplier device to fulfill the request.

A recording device at the location of the supplier can capture audio data for the location, and the audio data can be processed to determine sound metrics that are relevant to a level of activity at the location. The network computing system can estimate the level of activity at the location by using the sound metrics. For example, the sound metrics can be used in a trained computer model.

Based on the estimated level of activity at the location, the network computing system can predict an order preparation time for the request. A completion time for the request is then based on the current time plus the order preparation time.

In one aspect, the network computing system can select a service provider, from a pool of available service providers, to transport a set of items corresponding to the request, from the location of the supplier device to a delivery location specified by a user of the user device. The selection process can include determining that an arrival time of the service provider to the location of the supplier device is within a threshold duration of the completion time of the order request

In further aspects, after selecting the service provider, the network computing system can periodically determine a new level of activity at the location of the supplier device and update the order preparation time based on the new level of activity. Based on the updated order preparation time, the network computing system selects a new service provider, from the pool of available service providers, to transport the set of items corresponding to the request.

In some aspects, the sound metrics are determined from processing the audio data corresponding to sound captured during a period of time in which the supplier device received the order information.

In some aspects, the audio data is processed to isolate sounds that correlate with the level of activity at the location, for example, sounds of dishes and people talking. Furthermore, the sound metrics can include decibel levels for various frequency ranges, such as a band of frequencies corresponding to human voices. The sound metrics can also include a number of distinct voices identified in the audio data.

With reference to examples, the term “supplier” is interchangeable with “food preparation source.” Common examples of suppliers or food preparation sources include restaurants and kitchens.

As used herein, a user device refers to devices corresponding to desktop computers, cellular devices or smartphones, wearable devices, laptop computers, tablet devices, television (IP Television), etc., that can provide network connectivity and processing resources for communicating with the system over a network.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

System Overview

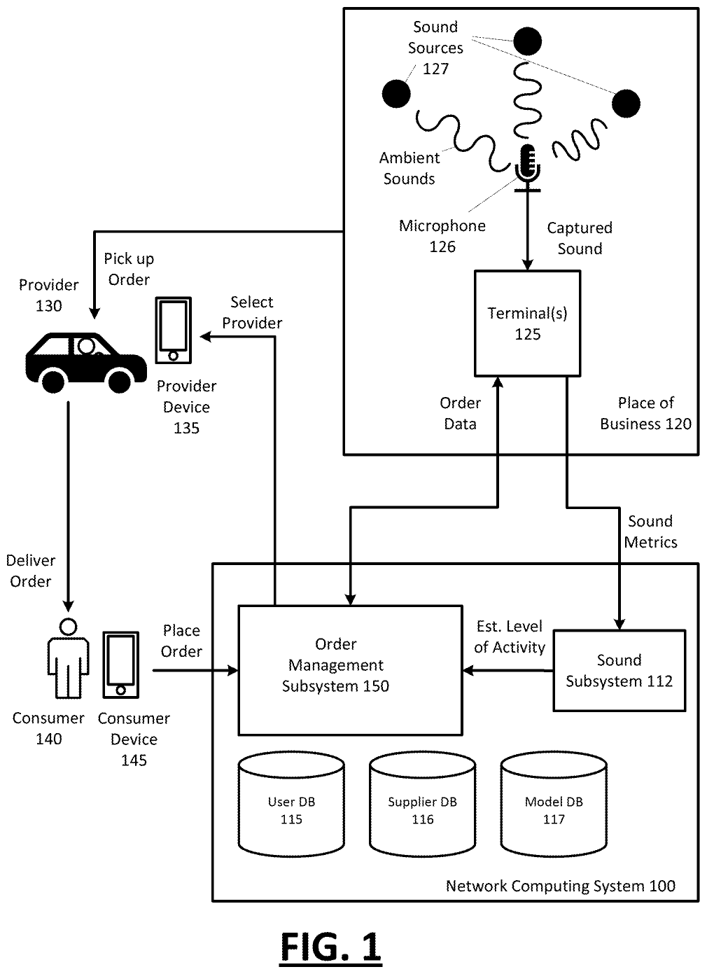

FIG. 1 illustrates an example system for busy restaurant detection, in accordance with some aspects. The example system uses a microphone 126 to monitor ambient sounds from sound sources 127 in a place of business 120 (e.g., a restaurant) in order to estimate how busy the restaurant is at various points of time. A network computing system 100 coordinates on-demand delivery of orders between ordering consumers 140, delivery providers 130, and a supplier at the place of business 120. The network computing system 100 can use the estimated busyness to more accurately predict order preparation times for the supplier, and the predictions can be used to determine when to dispatch a provider 130 to the place of business 120 and to inform the consumer 140 of an estimated delivery time.

In some aspects, the consumers 140 execute a service application on their consumer devices 145 to configure and transmit an order request to the network computing system 100. The order request can include a list of goods (e.g., food items, boxed items) for a supplier at the place of business 120 to prepare for the consumer 140.

The service providers 130 each utilize a service provider device 135 (e.g., a mobile computing device) to execute a transport application that links the service provider device 135 with the network computing system 100. The network computing system 100 can access location data, indicating the dynamic location of the service provider 130, from a location-based resource (e.g., a global navigation satellite system module) of the service provider device 135 via a service application. In addition to receiving the service provider's location, the network computing system 100 can transmit requests to the service providers 130 via the service application to enable the service providers 130 to receive the requests and perform corresponding services for the requesting consumers 140. In some examples, these services include picking up a requested order at the place of business 120 and delivering the order to the consumer 140.

In various examples described herein, the network computing system 100 can include an order management subsystem 150 to coordinate a completion time of an order request that is being prepared by a supplier (e.g., restaurant) with an estimated time of arrival of a provider at the location of the supplier (e.g., place of business 120). By estimating an order preparation time and selecting an appropriate provider 130 that can arrive at the place of business 120 at approximately the same time as the order completion time, the order management subsystem 150 can prevent or mitigate against occurrences of (i) a provider 130 arriving to the place of business 120 on time then having to wait an extended period of time for the supplier to prepare the order, and (ii) a supplier completing preparation of an order request before a selected provider 130 arrives at the place of business 120 to deliver the order to the consumer 140.

In order to estimate the order preparation time and select providers 130, the order management subsystem 150 can use computer models that predict order preparation time using features of the order (day of week, time of day, number of items, cost) and restaurant data (hardcoded prep time, location of the place of business 120). In order to add a contextual, real-time element to the order preparation time model, a microphone 126 at the place of business 120 can be sampled, and the captured sound processed, to estimate a level of activity in the restaurant. The order management subsystem 150 can use the estimated level of activity to better predict the order preparation time and select an appropriate provider 130 from a pool of providers. For example, if the estimated level of activity at the place of business 120 is low at the time an order is placed, the order management subsystem 150 may predict a preparation time of fifteen minutes and select a provider 130 who can arrive at the place of business 120 in approximately fifteen minutes. In contrast, if the estimated level of activity at the place of business 120 is high at the time the order is placed, the order management subsystem 150 may predict an increased preparation time of thirty minutes and select a provider 130 who can arrive at the place of business 120 in approximately thirty minutes.

In one use case, the order management subsystem 150 can periodically estimate a new level of activity at the place of business 120 after selecting a provider 130 to pick up an order. If a change in the estimated level of activity significantly changes the expected order preparation time (i.e., the change is above a certain threshold, such as ten minutes), the order management subsystem 150 can notify the previously selected provider 130 of the change in timing, such as through an alert displayed on the service provider application running on the provider device 135. Alternatively, the order management subsystem 150 notifies the previously selected provider 130 to cancel the pickup, and the order management subsystem 150 selects a new provider, from the pool of available service providers 130, whose estimated arrival time at the place of business 120 is a closer timing match for the updated order completion time.

In the context of food delivery, a consumer 140 places an order request with the network computing system 100 for delivery from a restaurant, and a service application running on a terminal 125 at the place of business 120 receives the order request from the network computing system 100. In addition to receiving order requests, the supplier can interact with the service application on the terminal 125 to perform actions such as accepting the order, updating a preparation status of the order, providing menus or descriptions (including text and images) of available items for delivery, setting a base preparation time for orders, etc.

In some aspects, the terminal 125 is a computing device located within the confines of the place of business 120. For example, the terminal 125 may be a tablet device in a fixed position near a register or the hostess booth at the front of a restaurant. In other examples, the terminal 125 is a mobile device that can be moved around within the restaurant. In general, the tablet device 125 is located within the place of business 120 somewhere that allows a microphone 126 with the tablet device 125 to capture sound in an area where the ambient sounds are representative of the level of activity of the business.

In some aspects, the microphone 126 is built in to the terminal 125, such is common with tablet devices. Alternatively, the microphone 126 can be a separate device that communicates with the terminal 125, either wirelessly or through a wired connection. In one aspect, the microphone 126 is an omni-directional microphone that picks up ambient sounds within the place of business 120. In another aspect, the microphone 126 is a directional microphone that is positioned and oriented within the place of business 120 to be more likely to pick up sounds from sound sources 127 that are relevant to the busyness of the restaurant and/or less likely to pick up irrelevant sounds. Relevant sound sources 127 can include people (e.g., customers and employees in the restaurant) and equipment (e.g., grills, ovens, microwaves, etc.).

Although FIG. 1 depicts a single terminal 125 and microphone 126, the place of business 120 can have multiple of either device. Accordingly, a supplier can install microphones 126 at various locations within the place of business 120 to more effectively capture ambient sounds from sound sources 127. For example, the supplier may place a microphone 126 in each of several rooms of a restaurant in order to capture the ambient sounds from sound sources 127 in those rooms.

The microphone 126 can be sampled at various intervals of time to capture sounds used to estimate the level of activity at the place of business 120. In one aspect, the service application running on the terminal 125 regularly samples the microphone 126 during times the restaurant is accepting orders or during open hours indicated in the service application. In another aspect, the microphone 126 is only sampled in response to receiving an order from the network computing system 100. Each sample from the microphone 126 can span a period of time, from a few seconds to a few minutes, in order to record enough sound to be representative of the current level of activity in the restaurant.

Once a sample is recorded, the terminal 125 can process the captured sound to isolate sounds that correlate with the level of activity in the restaurant, such as dishes clanging, people talking, a cash register opening, etc. The terminal 125 can also filter out sounds that have no bearing on the level of activity in the restaurant. The terminal 125 can also preprocess the captured sound to improve quality and remove unwanted noise, echoes, distortion, etc.

The terminal 125 can further analyze the captured sound to calculate one or more sound metrics that correlate with the level of activity in the restaurant. These sound metrics can then be used in a computer model that estimates the level of activity based on the sound metrics. In some aspects, the computer model is specific to the restaurant in order to account for the particular features of the restaurant, such as the distance of the microphone 126 from the sound sources 127 and the acoustics of the building. Alternatively or in addition, features of the restaurant are inputs to the model. The model can be created, trained, and implemented using any number of statistical techniques and/or machine learning frameworks, including neural networks, linear regressions, decision trees, etc.

In one implementation, the restaurant terminal 125 transmits the sound metrics to the network computing system 100, and a sound subsystem 112 on the network computing system 100 uses the sound metrics as input to the model to estimate the level of activity of the restaurant. The order management subsystem 150 can then determine the estimated preparation time for orders taking the estimated level of activity into account.

In another implementation, the service application on the terminal 125 stores a copy of the computer model and uses the sound metrics as input to the model locally. The restaurant terminal 125 uses the model to estimate the level of activity, determines an estimated preparation time for orders, and transmits the estimated preparation time to the network computing system 100. In a further implementation, the restaurant terminal 125 transmits the estimated level of activity to the network computing system 100, and the network computing system 100 can determine the estimated preparation time for orders placed with that restaurant.

One type of sound metric that can be used to determine the level of activity at the place of business 120 is the measured sound pressure level of the captured sound across the frequencies the microphone 126 can detect, which may include the average, minimum, and maximum levels over the sample period. For example, a certain restaurant may be busy when the average sound level in a given sample period is 80 dB and not busy at all at 60 dB. Another type of sound metric used to determine the level of activity is the measured sound pressure level of the captured sound across limited bands of frequencies, such as a band corresponding to human voices (e.g., 85-220 Hz).

In some aspects, the terminal 125 can analyze the captured sound to distinguish voices and count the number of sound sources 127 that correspond to a distinct customer in a restaurant. This count of customers can then be included in the sound metrics used as inputs to the computer model that estimates the level of activity of the restaurant.

In some aspects, the network computing system 100 trains the computer model used for estimating the level of activity at the place of business 120 based on the sound metrics. The network computing system 100 can also train computer models used for predicting the order preparation time based on the estimated level of activity. In the process of training, the network computing system 100 can consider the actual preparation time of a completed order request and any indications of busyness received from the terminal 125.

After a consumer 140 places an order with the network computing system 100 and the system transmits the order data to the terminal 125, an agent of the supplier at the place of business 120 or an automated system accepts the order, prepares the ordered items, and marks the order as ready to pick up through the service application running on the terminal 125. The service application transmits data to the network computing system 100 indicating when the order is accepted and when the order is ready to pick up. The order management subsystem 150 can determine the actual preparation time of the completed order request from the time elapsed between either when the order was placed or when the order was accepted and when the order was ready to pick up.

When the terminal 125 receives the order data for an order request, the agent of the supplier at the place of business 120 can choose whether to accept or decline the order. If the agent indicates that the order is declined because the restaurant is too busy, the network computing system 100 can flag corresponding audio data (i.e., the sound metrics) for a period of time around when the order was received at the terminal 125. The flagged audio data can be used as training data representative of a set of busy sound metrics in the computer model.

In one aspect, when the terminal 125 (or sound subsystem 112, depending on implementation) determines that the estimated level of activity at the place of business 120 is above a certain threshold, the terminal 125 displays a prompt on the user interface of the service application asking whether the restaurant is busy. If an agent of the supplier responds affirmatively to the prompt, the order management subsystem 150 factors the busy status of the restaurant into processes such as selecting a provider 130 to pick up the order. In addition, the network computing system 100 can use the response to the prompt, whether positive or negative, in combination with the sound metrics that triggered the prompt, as training data for the computer model that estimates the level of activity of the restaurant.

In another aspect, the terminal 125 can display the estimated level of activity on the user interface of the service application as determined from the sound metrics and computer model. Agents of the supplier at the place of business 120 can interact with the user interface of the service application to indicate whether the estimated level of activity is accurate or not. Their response, in combination with the sound metrics for a period of time around the response, can be used as training data for the computer model that estimates the level of activity of the restaurant.

When a provider 130 arrives at the place of business 120 to pick up an order, the provider 130 can interact with the service application on the terminal 125 to indicate their arrival. In one aspect, the provider 130 can interact with the user interface of the service application. In another aspect, the microphone 126 can record the voice of the provider 130, and the terminal 125 can recognize a keyword, passphrase, etc. that the provider 130 speaks to identify themselves. In further aspects, the provider 130 can also interact with the terminal 125 to indicate the current level of activity of the place of business 120, which the network computing system 100 can use as input to the model and training data for the model in combination with the sound metrics for the period of time around when the provider 130 interacts with the terminal 125.

The network computing system 100 can include a number of databases for storing consumer, provider, and supplier information as well as data for the computer models, including training data, weights and functions, etc. These databases can include a user database 115, supplier database 116, and model database 117.

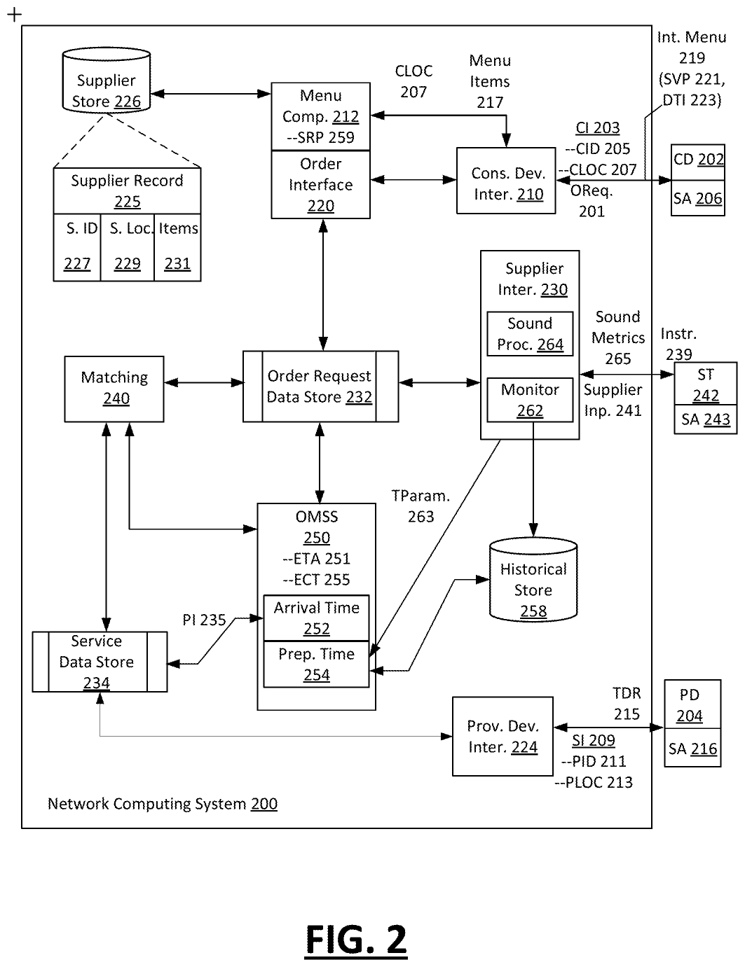

FIG. 2 illustrates a network computing system to coordinate completion of order requests with arrival times of transportation providers, according to one or more examples. In particular, a network computing system 200 implements control actions which target matching a time when a supplier (e.g., restaurant) completes an order request with an arrival time of a transportation provider (e.g., delivery person or transportation provider) at the location of the supplier or place of business. In examples, the system 200 can determine an expected preparation time of ordered items based on audio indicators of how busy the restaurant sounds. In this way, the system 200 can reduce the occurrence of wait times by transportation providers, while also reducing occurrences of transportation providers arriving late (e.g., minutes after when the food items have been prepared), which in turn, may cause the food items to deteriorate or lose their appeal when delivered to the requesting consumer.

With respect to examples as described, the system 200 can be implemented on a server, on a combination of servers, and/or on a distributed set of computing devices which communicate over a network such as the Internet. Still further, some examples provide for the network computing system 200 to be distributed using one or more servers and/or mobile devices. In some variations, the network computing system 200 is implemented as part of, or in connection with a network system, where, for example, operators use service vehicles to provide transport-related services between locations. In variations, the network computing system 200 may be implemented using mobile devices of users, including transportation providers and consumers, with the individual devices executing a corresponding service application that causes the computing device to operate as an information inlet and/or outlet for the network computing system 200.

In some examples, the system 200 implements an on-demand delivery platform in connection with applications that run on mobile devices of the population of users. The users can include those who order items from the delivery service through their respective computing device (“requesting consumer”), as well as those who receive items from the delivery service as part of a group (collectively termed “consumers” in examples as described). The users can also include suppliers, such as operators of restaurants, stores which provide prepared foods, and food preparers (e.g., independent chefs operating in professional kitchens). The providers can include individuals and fleet operators who provide transport services, such as in connection with delivery orders.

With reference to an example of FIG. 2, the system 200 includes a consumer device interface 210, an order interface 220, a provider device interface 224, a supplier interface 230, a matching component 240, and an order management sub-system (“OMSS 250”). Additionally, the system 200 can include one or multiple data stores which maintain information about consumers, suppliers, and providers. As described by some examples, the system 200 can be implemented in connection with a delivery service which enables consumers in a geographic region to request goods (e.g., food items, boxed items) from suppliers (e.g., restaurants) for delivery to their respective locations.

As described by various examples, the OMSS 250 estimates an order preparation time and eventual completion time of an order request that is being prepared by a supplier (e.g., restaurant) so that the matching component 240 can select a provider to arrive at the restaurant near the completion time of the order request. Thus, the OMSS 250 can prevent or mitigate against the occurrence of (i) a provider arriving to the location of the supplier on time and then having to wait an extended period of time for the supplier to prepare the order request which the provider is to deliver; and/or (ii) a supplier completing preparation of an order request before an assigned delivery arrives at the location of the supplier to deliver the order request.

The consumer device interface 210 includes or performs processes that run on the network-side of the system 200 to establish communication channels with individual devices of consumers. The consumers may operate mobile devices (represented in FIG. 2 by the consumer device 202) on which a corresponding service application 206 may execute. The consumers may operate respective service applications 206 to request delivery services, and in some variations, other types of transport-related services, such as human transport between a start location (or pickup location) and a destination (or drop-off). The service application 206 may obtain its current location 207 by interfacing with a satellite receiver or other location-aware resource of the consumer device 202.

According to some examples, the provider device 204 initiates communications with the system 200 using the service application 216. The service application 216 may correspond to a program (e.g., a set of instructions or code) that is downloaded and stored on the provider device 204 of the provider. The provider can launch the service application 216 to utilize the system 200 to receive transport delivery requests 215, and/or another type of service request (e.g., transport requests). The provider may operate a service vehicle to fulfill a transport delivery request 215. Once the communication channel is established by the provider device 204 using the service application 216, the provider device 204 may repeatedly or continuously communicate service information 209 to the network computing system 200. The service information 209 may include the provider's identifier 211, as well as the provider's current location 213, which may be determined by the service application interfacing with a satellite receiver of the provider device 204.

The provider device interface 224 includes or performs processes that run on the network-side of the system 200 to establish communication channels with individual devices of providers. For example, the consumer device interface 210 can establish secure sockets with different types of mobile devices, which providers of the system 200 can utilize when delivering orders and providing other services using their respective vehicles. In some examples, the providers operate mobile devices (represented in FIG. 2 by the provider device 204) on which a corresponding service application 216 may be operated. Among other functionality, the service application 216 can automate operations which include indicating the availability of the provider to provide service, communicating location information to enable the system 200 to monitor the location of the provider's vehicle, receiving information from the system 200 to facilitate the provider in receiving order requests and fulfilling order requests, and/or communicating information to the system 200 for various purposes.

The system 200 may include an active service status store 234 that maintains records that associate individual providers with their respective current location 213 and service status. By way of example, each provider may start a shift by operating the service application 216 (e.g., opening the application on the provider's device 204), and then toggling a state feature provided by the service application 216 to ‘on duty.’ The service application 216 communicates the activation of the state feature to the system 200 via the provider device interface 224. The provider device interface 224 processes the service information 209 received from individual providers. For each provider, the provider device interface 224 extracts and stores the current location 213 of the provider device 204 with the provider's identifier 211 in the service status store 234. As the provider's location changes (e.g., with the movement of the provider's vehicle), subsequent communications from the provider device 204 via the provider device interface 224 can be used to update the service status store 234. In this way, the service status store 234 may reflect the current location of each provider.

In some examples, the consumer device interface 210 and the provider device interface 224 can each include or use an application programming interface (API), such as an externally facing API, to communicate data with the consumer and provider devices 202, 204, respectively. By providing the externally facing API, the system 200 can establish secure communication channels via secure access channels over the network through any number of methods, such as web-based forms, programmatic access via RESTful APIs, Simple Object Access Protocol (SOAP), remote procedure call (RPC), scripting access, etc.

The supplier interface 230 may correspond to a programmatic interface that transmits order requests from consumers to a terminal of a supplier (shown as supplier terminal 242). In the context of food delivery, the supplier interface 230 transmits delivery orders to a computer system (e.g., reservation ordering system, point-of-sale device, dedicated take-out terminal, etc.) of the supplier. In some examples, the supplier may operate a mobile device on which a service application 243 is operated. The service application 243 can enable the supplier to receive service requests from the system 200. The supplier may access the system 200 via, for example, a website or application interface to accept order requests, as well as to provide information as to the preparation status of an order request. Additionally, the supplier may access the system 200 to provide menus or descriptions (including text and images) of available items for delivery.

In some aspects, the supplier terminal 242 uses a microphone to capture sounds within a restaurant in order to determine a level of activity at the restaurant at that time. The supplier terminal 242 can further analyze the captured sound to calculate one or more sound metrics 265 that correlate with the level of activity in the restaurant. These sound metrics 265 can then be used in a computer model that estimates the level of activity. In some examples, the supplier terminal 242 transmits the sound metrics 265 to the network computing system 200, and a sound processor 264 on the network computing system 200 uses the sound metrics 265 as input to the model to estimate an level of activity of the restaurant. The order management subsystem 250 can then determine the estimated preparation time for orders taking the estimated level of activity into account.

The system 200 may maintain a supplier profile store 226, which includes a record 225 for each supplier. Each supplier record 225 may associate a respective supplier with an account identifier 227, as well as a supplier location 229 and a set of deliverable items 231 provided by that supplier. The supplier may specify the deliverable items 231 via the supplier interface 230. The deliverable items 231 may be provided as an electronic document, or combination of records provided by the supplier, which can be retrievable and rendered on a consumer device 202 in the form of, for example, an interactive menu. By way of example, the supplier items 231 can be in the form of a restaurant menu, or items for a restaurant menu, which the consumer can render using the service application 206. The supplier record 225 can also include a base preparation time for orders, which the supplier can set through the service application 243.

According to examples, the consumer device 202 can generate a session request for the consumer device interface 210 when, for example, the service application 206 is launched. The session request may include consumer information 203, including an account identifier 205 as well as the current location 207 of the consumer device. In response to the session request being transmitted, the order interface 220 can initiate the order session for the consumer. In some examples, when the order session is initiated, the menu component 212 uses the current location 207 of the consumer to retrieve menu items 217, representing a selection of the supplier's deliverable items 231, from the supplier profile store 226. The menu component 212 can also utilize a service range parameter 259 to select menu items 217 from the supplier's store. The service range parameter 259 can define a distance (e.g., travel distance) from the service location of the desired order request, from which available suppliers may be made available to the consumer for the purpose of delivery orders. Accordingly, the menu component 212 may use the service range parameter 259 in selecting suppliers, from which menu items 217 can be selected. As an addition or variation, the service range parameter 259 can define a range for when a consumer can place a batch order, where portions of a delivery order are prepared by different suppliers who fit a condition or criteria of the range parameter 259.

According to examples, the consumer device interface 210 communicates one or more interactive menus 219 to the consumer device 202, via the service application 206, based on the menu items 217 that match to the current location 207 of the consumer. As described with some examples below, the interactive menus 219 may also communicate one or more service value parameters 221, indicating a charge or consideration which the consumer will incur for receiving delivery of a requested item from the supplier.

The order interface 220 can process the selection input of the consumer during a session. When the consumer selects an item for an order request 201, the order interface 220 can place an identifier for the selected menu item in a checkout queue for the consumer. Once the order interface 220 signals completion of an order, the order interface 220 can place a corresponding order request 201 in an order request data store 232. The order request 201 can identify each item the requester selected, the supplier the item was selected from, and the delivery location for the order request 201. When the order request 201 is complete, the OMSS 250 can initiate a workflow 256 for the order request 201.

In examples, the OMSS 250 can trigger the matching component 240 to initiate a matching process in which a provider is selected and assigned to the order request 201. The matching component 240 can match the order request 201 to an available provider based at least in part on the current location of individual providers with respect to the location of the supplier. In some variations, the matching component 240 may also match the order request 201 based on the desired arrival time for the provider at the location of the supplier. Thus, for example, the proximity of the provider may not necessarily be a decisive selection criterion for selecting a given provider.

In some variations, the system 200 includes one or more monitoring processes (represented by monitoring component 262) that are performed for completed order requests. The monitoring component 262 can be performed by a supplier to determine timing parameters 263 of individual orders as the orders are prepared and delivered. The monitoring component 262 can determine values for timing parameters 263 that reflect, for example, (i) an order preparation time of an order, (ii) a time to pick up of the completed order, indicating the length of time between when the order request 201 was completed by the consumer and when a provider picked up the corresponding delivery order; and/or (iii) a time to deliver an order, meeting a duration between when a consumer completes an order request 201 and when the provider completes the delivery of the corresponding delivery order to the consumer.

In examples, the monitoring component 262 can also utilize input from the provider (e.g., provided via the provider device interface 224) reflecting, for example, that the provider is waiting at the supplier's location for a delivery order. The monitoring component 262 may also receive input from the supplier reflecting, for example, that the provider has arrived and/or departed the location of the supplier with a delivery order. Still further, the monitoring component 262 can receive input from a beacon or other specialized resource at or near a location of the supplier, to detect proximity of designated individuals using proximity detection resources (e.g., via detection of Bluetooth signal transmission or Near Field Communication (NFC) signals). Based on the various inputs, the monitoring component 262 can determine the actual completion time for goods of a supplier. In such examples, the monitoring component 262 can record historical information for individual suppliers with a historical data store 258. In this manner, the historical data store 258 can record completion times for individual suppliers as well as for individual goods of the supplier. The historical data store 258 can also reference the recorded completion times to contextual information, such as the time of day or day of week. The recorded completion times can be obtained from, for example, parametric information communicated by the monitoring component 262, the supplier profile store 226, and/or information reported by the suppliers.

In examples, the monitoring component 262 can also obtain information to record for individual suppliers and their respective goods using feedback from consumers. For example, consumers can be prompted to provide feedback for a particular supplier, at which time the consumer can reflect information such as the delivery time for the particular order request. The feedback can be recorded with the supplier profile store 226, which the monitoring component 262 can access and record as historical information for the supplier. As an addition or variation, the supplier can provide a completion time log that indicates the preparation time for individual order requests.

In some examples, the monitoring component 262 can also obtain and record contextual information as feedback for completed order requests 201. The monitoring component 262 can obtain contextual information such as relating to weather, traffic, or other events from, for example, the consumer device 202 used to place an order and/or third-party sources.

With further reference to FIG. 2, the OMSS 250 implements processes to coordinate a completion time of items of an order request, or portions thereof, with an estimated arrival time of a provider that is to deliver the order request to a location of a requesting consumer.

Estimation of Arrival Time

In more detail, an example of FIG. 2 provides for the OMSS 250 to utilize arrival time logic 252 to estimate, for individual order requests, the arrival time of selected providers at the location of corresponding suppliers, where goods (e.g., food items, boxed items) of the respective order requests are prepared. The arrival time logic 252 can utilize information from the service data store 234 to obtain provisioning information 235 for a sub-region of individual suppliers. For a given order request, the provisioning information 235 can include, for example, estimations of (i) a number of providers who are within a sub-region of a respective supplier for the order request; (ii) a number of providers who can travel to the location of the respective supplier within a threshold period of time; (iii) a number of pending order requests for which corresponding providers have been assigned; and/or (iv) a number of open order requests for which corresponding providers have not been assigned.

In examples, the arrival time logic 252 can use or access provisioning functionality to determine provisioning information 235 by monitoring transport providers in a given region, via, for example, the service data store 234. The provisioning functionality can estimate the provisioning information 235 from monitoring the transport providers that are indicated as being active with the service data store 234, and further by determining a number of available providers for delivering the completed order request at one or more instances after the order request is received. In such examples, the arrival time logic 252 can determine the ETA 251 based in part on the estimated time interval which the matching component 240 may require to select a transport provider from the available providers.

In some examples, the arrival time logic 252 can also periodically predict a trip duration (or portion thereof) of a selected provider from the provider's current location to the location of the supplier. The arrival time logic 252 can utilize, for example, the service data store 234 to obtain a recent or current location of individual providers who have been assigned for delivering completed order requests.

As an addition or variation, the provisioning information 235 can also include prospective indicators of service requests and/or order requests, such as an estimate of a number of potential requesters for transport services provided through the system 200. The potential requesters may correspond to, for example, users who have opened one or more service applications from which order requests and/or transport requests can be (but have not been) made.

In variations, the OMSS 250 can utilize the arrival time logic 252 to estimate the arrival times for providers at the location of suppliers based at least in part on historical information relating to the arrival time for providers at specific locations of individual suppliers, and/or within a sub-region that includes the location of individual suppliers. By way of example, the arrival time logic 252 can utilize a specific time interval (e.g., time of day and day of week) and location or sub-region of a given supplier, in order to predict the arrival time for a provider at the location of the supplier. The arrival time logic 252 can also utilize other contextual information, such as weather or event information, to predict the arrival times of providers at the locations of respective suppliers.

In some examples, the OMSS 250 utilizes the arrival time logic 252 to estimate the arrival time for an order request 201 in advance of a provider being selected for the order request 201. For a given order request 201, the estimation of the arrival time can include separate determinations of at least one of (i) an estimated duration to match a provider to an order request, and (ii) an estimated duration for a matched provider to travel to the location of the supplier.

In some aspects, the arrival time logic 252 is provided as a service that generates an estimated time of arrival (“ETA”) 251 for the OMSS 250, where the ETA 251 identifies a window of time during which a provider is most likely to arrive at the location of a supplier. The OMSS 250 can specify the location of the supplier at a current instance to determine the ETA 251.

Additionally, the OMSS 250 can obtain the ETA 251 without triggering the matching component 240 to select a provider. Rather, the 252 can be implemented to generate, for example, a phantom transport request, from which the matching component 240 makes a phantom selection of a provider (e.g., provider is not notified about the selection). Once obtained, the OMSS 250 can receive or otherwise determine updates to the ETA 251.

In some examples, the OMSS 250 can utilize the ETA 251 to trigger or otherwise cause the matching component 240 to initiate a matching process for selecting a provider to handle an order request. Thus, for example, the OMSS 250 can utilize the ETA 251 (as obtained without an actual provider being matched) to delay, or set a future time (e.g., 5 minutes later) when the matching component 240 is to be triggered into selecting a provider for delivery of a given order request.

Estimation of Completion Time

The OMSS 250 can utilize preparation time logic 254 to determine an estimated completion time (“ECT”) 255 of individual order requests by respective suppliers. In examples, the ECT 255 corresponds to an estimated window of time, such as provided by a probabilistic determination that is predictive as to when a given supplier is most likely to complete preparation of the goods of a given order request 201. In variations, the estimated completion time 255 can further correspond to the time when an order request 201 is ready for pickup by a provider. Thus, the ECT 255 can take into account a time which the supplier may need to package an item for delivery.

In some examples, the OMSS 250 can use the preparation time logic 254 to determine the ECT 255 of the order request 201. The preparation time logic 254 utilizes historical information (e.g., such as provided from historical data store 258), relating to the preparation time of goods by suppliers, to determine the ECT 255 for individual order requests 201. As an addition or variation, the preparation time logic 254 can determine the ECT 255 from completion time reports provided by the suppliers. For example, suppliers may associate completion times with menu items via the supplier interface 230. In variations, the suppliers can respond to receiving an order request 201 from system 200 with supplier input 241 that identifies an estimated completion time for the order request 201. Still further, the preparation time logic 254 can determine the ECT 255 based on a predicted preparation time of individual items, such as the item of an order request that is expected to take the longest to prepare.

As an addition or variation, the preparation time logic 254 can determine the ECT 255 for an order request 201 by monitoring recent order requests of the supplier. For example, the preparation time logic 254 can estimate the ECT 255 from parametric information determined by monitoring other order requests 201 to the same supplier from an earlier time period (e.g., in past hour). For example, the preparation time logic 254 can tune or weigh the ECT 255 to account for delays, detected by monitoring component 262.

As a further addition or variation, the preparation time logic 254 can determine the ECT 255 for an order request 201 based on the estimated level of activity at the restaurant as determined from the sound metrics 265.

In some examples, the preparation time logic 254 maintains preparation times of individual items on menus of individual suppliers. For example, the preparation time of individual items can be determined based on the recipe used for each item. The preparation time logic 254 can utilize, for example, a library of item preparation times to determine the ECT 255 for an order request 201. The preparation time logic 254 can also correlate preparation times to observed completion times to calibrate, for example, the determinations of ECT 255. For example, the supplier may be observed to generally require at least 20 additional minutes to prepare and package an item, as compared to the preparation time provided by a recipe for the item. Additionally, the preparation time logic 254 can further adjust the ECT 255 to accommodate, for example, specific items on individual menus which have longer preparation times.

As described with various examples, the OMSS 250 can (i) use the arrival time logic 252 to obtain the ETA 251 for the order request 201, and (ii) use the preparation time logic 254 to determine the ECT 255 for the order request 201 by the specified supplier. The OMSS 250 can trigger the matching component 240 to initiate a matching process for selecting a provider of the order request 201, at an instance that is determined by the ETA 251 and the ECT 255. If the ECT 255 exceeds the ETA 251, the OMSS 250 can communicate the order request 201 to the supplier to initiate preparation of the order request 201. The OMSS 250 can then trigger the matching component 240 to initiate the matching process based on the ETA 251, such that a difference between the ECT 255 and the ETA 251 is within a threshold time interval.

On the other hand, if the ETA 251 exceeds the ECT 255, the OMSS 250 can implement, as part of the workflow 256, a coordination action 253 that triggers or otherwise influences the moment when the supplier begins preparation of the items of the order request 201. The coordination action 253 can correspond to, for example, (i) timing when the supplier receives the order request 201, and/or (ii) communicating instructions to the selected supplier to influence the completion time of the order request. As examples instructions can communicate, for example, (i) the time when the selected supplier should start beginning preparation of the order request 201, (ii) the time (or window of time) during which the provider should have the order request 201 completed, and/or (iii) a delay time or action that the supplier should perform before the supplier begins preparation of the order request, or alternatively, performs an intermediate step in the preparation of the items for the order request.

In some examples, the OMSS 250 can perform one or more monitoring processes. When, for example, the matching component 240 is triggered to find a matching provider, the OMSS 250 can receive one or more updates from the matching component 240 to communicate a status of the order request 201. For example, the OMSS 250 can receive updates from the matching component 240 which indicate the order request 201 has just been assigned to a provider. If the order request 201 is unassigned, the updates from the matching component 240 can, for example, update the OMSS 250 as to the ETA 251, to accommodate, for example, delays in matching the order request 201 to a provider. Still further, the matching component 240 can provide an update to the OMSS 250 to reflect that an assigned provider has been reassigned or is otherwise unavailable. Still further, the OMSS 250 can communicate with, for example, the provider status store 234 to track the location of the provider. The OMSS 250 can use the arrival time logic 252 to recalculate the ETA 251 to account for the progress of the selected provider on route to the location of the supplier of the order request 201. For example, the OMSS 250 can also use the arrival time logic 252 to lessen or lengthen the ETA 251 from the original calculation made with initiation of the workflow 256 of the order request 201.

In some variations, the OMSS 250 can adjust the ECT 255 based on timing parameters 263 detected by the monitoring component 262. For example, the monitoring component 262 can detect completion times of immediately preceding order requests for the same supplier to increase from their respective expected completion times. Thus, the monitoring component 262 can be used to predict events, such as delays by the supplier, in absence of input from the supplier.

Methodology

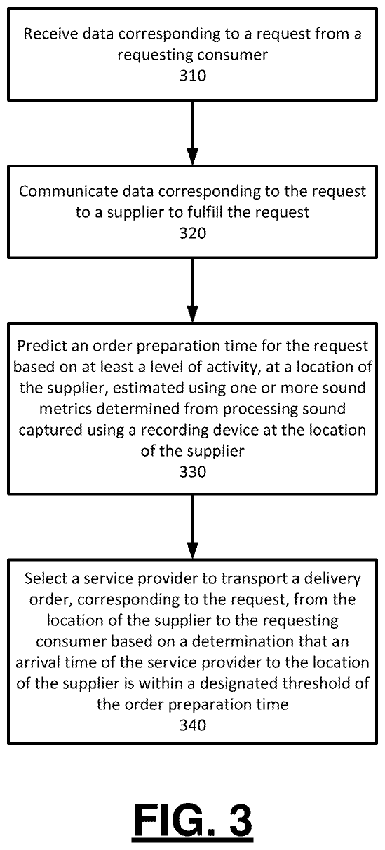

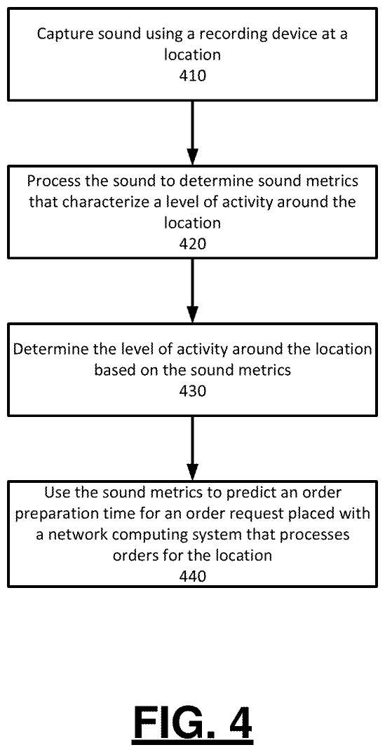

FIG. 3 illustrates an example method for selecting a service provider to transport a delivery order, according to one or more examples. FIG. 4 illustrates an example method for predicting an order preparation time, according to one or more examples. While operations of the methods may be described below as being performed by specific components, modules or systems, it will be appreciated that these operations need not necessarily be performed by the specific components identified, and could be performed by a variety of components and modules, potentially distributed over a number of machines. Accordingly, references may be made to elements of the network computing system and terminal for the purpose of illustrating suitable components or elements for performing a step or sub step being described. Alternatively, at least certain ones of the variety of components and modules described in the network computing system can be arranged within a single hardware, software, or firmware component. It will also be appreciated that some of the steps of this method may be performed in parallel or in a different order than illustrated.

With reference to FIG. 3, a network computing system, such as network computing system 100 or 200, can receive data corresponding to a request from a requesting consumer (310). The network computing system can communicate data corresponding to the request to a supplier to fulfill the request (320). The network computing system can predict an order preparation time for the request based on at least a level of activity, at a location of the supplier, estimated using one or more sound metrics determined from processing sound captured using a recording device at the location of the supplier (330). The network computing system can select a service provider to transport a delivery order, corresponding to the request, from the location of the supplier to the requesting consumer based on a determination that an arrival time of the service provider to the location of the supplier is within a designated threshold of the order preparation time (340).

With reference to FIG. 4, a supplier terminal captures sound using a recording device at a location, such as a restaurant (410). In some aspects, the supplier terminal processes the sound to determine sound metrics that characterize a level of activity around the location (420). In some aspects, a network computing system determines the level of activity around the location based on the sound metrics (430). The network computing system can use the sound metrics to predict an order preparation time for an order request placed with a network computing system that processes orders for the location (440).

Device

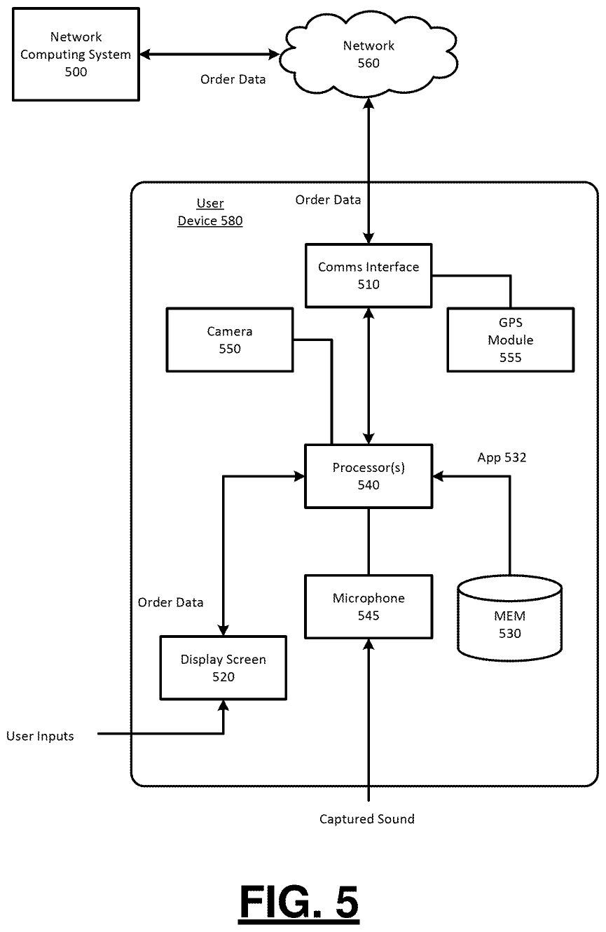

FIG. 5 is a block diagram illustrating an example computing device executing and operating a designated service application for communicating with a network computing system, according to examples described herein. In many implementations, the user device 580 can comprise a mobile computing device, such as a smartphone, tablet computer, laptop computer, VR or AR headset device, and the like. As such, the user device 580 can include typical telephony features such as a microphone 545, a camera 550, and a communication interface 510 to communicate with external entities using any number of wireless communication protocols. In certain aspects, the user device 580 can store a service application 532 in a local memory 530. In many aspects, the user device 580 further stores information corresponding to a contacts list and calendar appointments in the local memory 530. In variations, the memory 530 can store additional applications executable by one or more processors 540 of the user device 580, enabling access and interaction with one or more host servers, such as the network computing system 500, over one or more networks 560. With reference to FIG. 1, the user device 580 can represent any of the terminal 125, provider device 135, or consumer device 145.

In response to user input, the service application can be executed by a processor 540, which can cause an application interface to be generated on a display screen 520 of the user device 580. The application interface can enable users to, for example, check current price levels and availability for the on-demand arrangement service. In various implementations, the application interface can further enable users to place order requests with the network computing system 500, receive and accept requests to pick up and deliver orders, and receive order requests to prepare for pickup.

In some aspects, the user device 580 acts as an order terminal for a restaurant which receives requests for orders from the network computing system 500. The microphone 545 can capture ambient sounds in the restaurant, and the processor 540 can analyze the captured sounds to determine a set of sound metrics that characterize a level of activity in the restaurant.

The user device 580 can receive and transmit order data, including requests to order items, requests to pick up and deliver items, and requests to prepare items, via a communications interface 510 to the backend network computing system 500 over a network 560. In various examples, the user device 580 can further include a GPS module 555, which can provide location data indicating the current location of a consumer or provider to the network computing system 500. In alternative aspects, hard-wired circuitry may be used in place of or in combination with software instructions to implement aspects described herein. Thus, aspects described are not limited to any specific combination of hardware circuitry and software.

Computer System

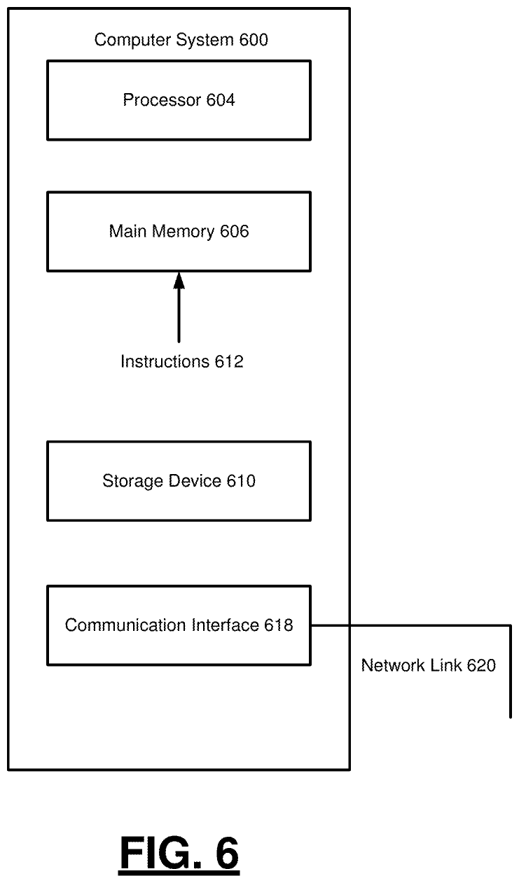

FIG. 6 is a block diagram that illustrates a computer system upon which aspects described herein may be implemented. For example, in the context of FIG. 1, the network computing system 100 may be implemented using one or more servers such as described by FIG. 6.

In an aspect, computer system 600 includes processor 604, memory 606 (including non-transitory memory), storage device 610, and communication interface 618. Computer system 600 includes at least one processor 604 for processing information. Computer system 600 also includes the main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. The storage device 610, such as a magnetic disk or optical disk, is provided for storing information and instructions. The communication interface 618 may enable the computer system 600 to communicate with one or more networks through use of the network link 620 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 600 for implementing the techniques described herein. According to one aspect, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A network computing system comprising:
a memory resource to store instructions; and
one or more processors using the instructions stored in the memory resource to perform operations including:
receiving, over one or more networks, data corresponding to a request from a user device;
based on at least a portion of the data corresponding to the request, transmitting order information to a supplier device to fulfill the request;
determining a level of activity, at a location of the supplier device, using one or more sound metrics determined from audio data corresponding to sound captured using a recording device at the location of the supplier device; and
predicting an order preparation time for the request based on at least the level of activity.

2. The network computing system of claim 1, wherein the one or more processors use the instructions to perform operations including:
selecting a service provider, from a pool of available service providers, to transport a set of items corresponding to the request, from the location of the supplier device to a delivery location specified by a user of the user device, wherein selecting the service provider includes determining that an arrival time of the service provider to the location of the supplier device is within a threshold of the order preparation time.

3. The network computing system of claim 2, wherein the one or more processors use the instructions to perform operations including:
determining a new level of activity at the location of the supplier device after selecting the service provider;
updating the order preparation time based on the new level of activity; and
based on the updated order preparation time, selecting a new service provider, from the pool of available service providers, to transport the set of items corresponding to the request.

4. The network computing system of claim 1, wherein the one or more sound metrics are determined from processing the audio data corresponding to sound captured during a period of time in which the supplier device received the order information.

5. The network computing system of claim 4, wherein the audio data is processed to isolate sounds that correlate with the level of activity at the location.

6. The network computing system of claim 5, wherein the sounds that correlate with the level of activity at the location include sounds of dishes and people talking.

7. The network computing system of claim 1, wherein the one or more sound metrics include decibel levels for a band of frequencies corresponding to human voices.

8. The network computing system of claim 1, wherein the one or more sound metrics include a number of distinct voices identified in the audio data.

9. A method of operating a network computing system, the method being implemented by one or more processors and comprising:
receiving, over one or more networks, data corresponding to a request from a user device;
based on at least a portion of the data corresponding to the request, transmitting order information to a supplier device to fulfill the request;
determining a level of activity, at a location of the supplier device, using one or more sound metrics determined from audio data corresponding to sound captured using a recording device at the location of the supplier device; and
predicting an order preparation time for the request based on at least the level of activity.

10. The method of claim 9, further comprising:
selecting a service provider, from a pool of available service providers, to transport a set of items corresponding to the request, from the location of the supplier device to a delivery location specified by a user of the user device, wherein selecting the service provider includes determining that an arrival time of the service provider to the location of the supplier device is within a threshold of the order preparation time.

11. The method of claim 10, further comprising:
determining a new level of activity at the location of the supplier device after selecting the service provider;
updating the order preparation time based on the new level of activity; and
based on the updated order preparation time, selecting a new service provider, from the pool of available service providers, to transport the set of items corresponding to the request.

12. The method of claim 9, wherein the one or more sound metrics are determined from processing the audio data corresponding to sound captured during a period of time in which the supplier device received the order information.

13. The method of claim 12, wherein the audio data is processed to isolate sounds that correlate with the level of activity at the location.

14. The method of claim 13, wherein the sounds that correlate with the level of activity at the location include sounds of dishes and people talking.

15. The method of claim 9, wherein the one or more sound metrics include decibel levels for a band of frequencies corresponding to human voices.

16. The method of claim 9, wherein the one or more sound metrics include a number of distinct voices identified in the audio data.

17. A non-transitory computer-readable medium that stores instructions, executable by one or more processors, to cause the one or more processors to perform operations that comprise:
receiving, over one or more networks, data corresponding to a request from a user device;
based on at least a portion of the data corresponding to the request, transmitting order information to a supplier device to fulfill the request;
determining a level of activity, at a location of the supplier device, using one or more sound metrics determined from audio data corresponding to sound captured using a recording device at the location of the supplier device; and
predicting an order preparation time for the request based on at least the level of activity.

18. The non-transitory computer-readable medium of claim 17, wherein the one or more processors use the instructions to perform operations including:
selecting a service provider, from a pool of available service providers, to transport a set of items corresponding to the request, from the location of the supplier device to a delivery location specified by a user of the user device, wherein selecting the service provider includes determining that an arrival time of the service provider to the location of the supplier device is within a threshold of the order preparation time.

19. The non-transitory computer-readable medium of claim 18, wherein the one or more processors use the instructions to perform operations including:
determining a new level of activity at the location of the supplier device after selecting the service provider;
updating the order preparation time based on the new level of activity; and
based on the updated order preparation time, selecting a new service provider, from the pool of available service providers, to transport the set of items corresponding to the request.

20. The non-transitory computer-readable medium of claim 17, wherein the one or more sound metrics are determined from processing the audio data corresponding to sound captured during a period of time in which the supplier device received the order information.
